(19) United States
(12) Patent Application Publication
(10) Pub. No.: US 2015/0323690 A1
(43) Pub. Date: Nov. 12, 2015

(54) SYSTEM AND METHOD FOR PROCESSING DATA

(71) Applicant: DIVESTCO INC., CALGARY (CA)

(72) Inventors: STEPHEN POPADYNETZ, CALGARY (CA); MICHAEL DENNIS, OKOTOKS (CA); COREY STEWART, CALGARY (CA); MATHEW HEPTON, CALGARY (CA)

(73) Assignee: DIVESTCO INC., CALGARY (CA)

(21) Appl. No.: 14/708,010

(22) Filed: May 8, 2015

Related U.S. Application Data
(60) Provisional application No. 61/990,218, filed on May 8, 2014.

(51) Int. Cl. G01V 1/34; G01V 1/24

(52) U.S. Cl. CPC G01V 1/345; G01V 1/24

(57) ABSTRACT

The present invention relates to a system and method that provides a user with an ability to use a secondary device to take a more detailed look at nuances within a captured seismic data set. The present invention allows the user to view a scaled image of the seismic data that is at a different scale than what is displayed on a primary device. Optionally, the secondary device is a mobile device that is wirelessly connected to the primary device. The present invention also enables the user to interpret the captured seismic data using the secondary device in real time while maintaining a macro view on the primary device. The user may annotate the scaled image regarding picked horizons and the information regarding the location of the annotations on the scaled image are then processed by the primary device and then scaled image on the secondary device is updated.

### FIELD OF INVENTION

This disclosure generally relates to data analysis, in particular a system for assisting with the analysis of large amounts of data, such as seismic data and methods of using same.

### BACKGROUND

The costs of drilling for new hydrocarbons ‘plays’ can range from $1 million up to $15 million depending on the depth and complexity of the drilling. As an example, daily operating costs can run from $150,000/day to $400,000/day. With these kind of economic pressures, oil and gas producers must try to ensure that where they drill is optimized for accuracy and production output. Costs for early abandonment, because of low yields, or drilling twice are extremely prohibitive.

Typically, the decision of where and how to drill is informed by seismic information. Seismic information, which may also be referred to as seismic data, provides a representation of geological formations within the earth. The seismic data can be captured by introducing elastic energy, which may comprise one or both of P-waves and S-waves, into an underground section of the earth that is being evaluated for a possible drilling operation. The reflections and refractions of the P-waves and the S-waves can be captured by seismic receivers and then translated into raw seismic data. The captured seismic data can be transformed into various types of visual representations to help an Interpreting Geophysicist, or other type of technical analyst, interpret the physical and structural properties of the underground geological-formations.

Captured seismic data may be two-dimensional (2D) or three dimensional (3D). The 2D seismic data is a linear dataset that is generated by a series of vertical shot points and seismic receiver's that are positioned on the surface of the section of the earth that is being evaluated. The 3D seismic data is a grid of captured seismic data that is generated by an array of shot points and seismic receivers.

The captured seismic data may be visualized by a seismic trace that represents the seismic data recorded for a single channel. The seismic trace represents elastic responses to velocity and density, which are measured via P and S waves transmitting to a receiver (for 2D seismic data) or an array of receiver's (for 3D seismic data) on the surface.

The captured seismic data is interpreted by the steps of defining structural and stratigraphic plays which occur through the analysis of the captured seismic data. The Interpreting Geophysicist may use various geophysical calculations and techniques to interpret the seismic data. Some of the more commonly used techniques include log analysis, capturing of seismic information, remote sensing of rocks, gridding, contouring and the use of advanced mathematical equations.

The Interpreting Geophysicist must be able to interpret between 10 and 1000 gigabytes of captured seismic data and determine if there may be underground structures, such as salt domes, sand domes or fault lines that may have trapped hydrocarbons. The Interpreting Geophysicist must also interpret the large data set to determine an optimal place from which to access those underground structures. A misinterpretation of even small subsets of the large data set can dramatically change the success and profitability of a well. The Interpreting Geophysicist will interpret either alone or in small teams. Following which, the Interpreting Geophysicist, or the team, must rationalize their conclusions as to where to direct drilling resources, to both their superiors and to senior members within the production company.

An important part of the Interpretation process is identifying key events in either 2D or 3D seismic data. A key event is a feature that appears in the captured seismic data that relates to a diffraction, reflection or refraction caused by a subterranean geological formation influencing the seismic energy that is generated by a seismic event generator. A key event can be found in a series of continuous traces or within a single trace within the captured seismic data. A key event can be used to identify a horizon or indicate a geological structural change such as a fault. Once identified, the Interpreting Geophysicist will pick horizons within the data set based upon the key events. Picking a horizon is a process of marking of a horizon event within the seismic data. A horizon pick can be various features within the captured seismic data that the interpreter has identified as being of interest, such as, but not limited to a peak, a trough or a zero crossing. A peak is a continuous section of high amplitude values. A trough is a continuous section of low negative amplitude values. A zero crossing is likely a point of contact between two different rock types which have different density, porosity or seismic velocities. The horizons serve as a baseline for further analysis and play a major role in the results of the entire interpretation process.

Seismic interpretation relies on the Interpreting Geophysicist's ability to visually identify the key events within the captured seismic data, and to do so it is helpful to be able to visualize the captured seismic data in different ways and from different perspectives.

### SUMMARY

The present invention relates to a system and method that provides a user, such as an Interpreting Geophysicist, with an ability to use a secondary device to take a more detailed look at nuances within captured seismic data. The present invention allows the user to view the seismic data at a different scale than what is displayed on a primary device, which is often a desktop workstation. Optionally, the secondary device is a mobile device that is wirelessly connected to the primary device. The present invention also enables the user to interpret the captured seismic data using the secondary device in real time. For example, the user may pick horizons that are based upon visualizing one or more key events within the scaled image that is displayed on the secondary device. This may help increase accuracy and reduce costly mistakes that may be associated with misinterpreting the seismic data. The present invention may also offers the user with an additional tool when presenting their interpretation to potential investors, as the secondary device can be used to show true representations of the seismic data set, in real time, for technical reviewers of the data being presented.

One embodiment of the present invention provides a method for processing data. The method comprises the following steps: retrieving non-modifiable data; rendering a first image of the non-modifiable data; making the first image available for display on a primary device; receiving a selected portion from within the first image; rendering a scaled image of the selected portion to substantially match the dimensions of a secondary device display; and communicating the scaled image to a secondary device.

Another embodiment of the present invention provides a system for processing data. The system for comprises a primary device, a secondary device and a network that enables communication between the first device and the second device. The primary device performs steps of: retrieving non-modifiable data; rendering a first image of the seismic data; making the first image available for display on the primary device; receiving a selected portion from within the first image; rendering a scaled image of the selected portion to substantially match the dimensions of a secondary device display; and communicating the scaled image to the secondary device.

As described above and further below, the secondary device may be a mobile device. The practical use of mobile devices for analysis of large data sets, such geophysical and seismic data sets has typically been limited due to the large amount of data, and the high graphics requirements for image processing, which is also referred to as rendering. The present invention may address this limitation by performing the image processing and computations on the primary device, with scaled and magnified images, which may also be referred to as a scaled view or a detailed view, of areas of interest passing through a network to one or more secondary devices. Interactions and/or gestures for example, pointing/selecting on the secondary device generate annotations on the scaled image that are sent back to the primary device for further processing. The primary device can synchronize both a macro view, which may also be referred to as a coarse view, on the primary device and the scaled image on the secondary device, which may include updating the macro view and the scaled view to depict the annotations made on the secondary device.

By updating only the annotation on the scaled image on the secondary device and compressing the annotations when communicating with the desktop workstation, this invention reduces network bandwidth and overcomes the memory, graphic and processing limitations that presently limit the functionality of mobile devices in the analysis of large data sets. This also ensures the user experience of viewing and manipulating the data is responsive and interactive in real time on the secondary device.

Other applications of the present invention include applications where a large data set is displayed to show an over-all or environmental view, such as for example a three-dimensional computer-aid-design rendering or computer-aid-modelling, wherein it is desirable to simultaneously view, and manipulate, edit, and change a feature or features within the large data set which are better or more clearly viewed in an enlarged scaled view.

### BRIEF DESCRIPTION OF DRAWINGS

Various example embodiments of the present invention are described in detail below, with reference to the accompanying drawings. The drawings may not be to scale and some features or elements of the depicted embodiments may purposely be embellished for clarity. Similar reference numbers within the drawings refer to similar or identical elements. The drawings are provided only as examples and, therefore, the drawings should be considered illustrative of the present invention and its various aspects, embodiments and options. The drawings should not be considered limiting or restrictive as to the scope of the invention.

FIG. 1 is a schematic representation of one example of a prior art data display that interacts with software.

FIG. 2 is an elevation view, schematic of one embodiment of an example system for assisting with data interpretation.

FIG. 3 is a schematic of an example macro view of a seismic fault as viewed using an example parent device of the system in FIG. 2.

FIG. 4 is a close-up view of the area of interest depicted in FIG. 3 as displayed on an example secondary device.

FIG. 5 is a schematic representation of an example data display that interacts with software for displaying images on a secondary device.

FIG. 6 is a schematic representation of an example data display that interacts with software for displaying images on a secondary device and for exchanging information between primary device and a secondary device.

FIG. 7 is a schematic representation of an example data display that interacts with software for displaying images on a secondary device and for exchanging information between primary device and a secondary device further including an auto horizon picker engine.

FIG. 8 is the example data display of FIG. 7 further including an application on the secondary device.

FIG. 9 is the example data display of FIG. 8 further including a map horizon rendering engine.

### DETAILED DESCRIPTION

This disclosure provides a method and system that are designed to improve a user's work flow. For example, the user may be an Interpreting Geophysicist or other technically trained individual who is interpreting a large set of data, such as captured seismic data. The user's workflow may be improved in, for example, three scenarios by allowing: (1) an individual user; (2) the team; or (3) the final decision making body to interactively examine and change the view of small areas of horizon picks within the captured seismic data set in a detailed view on a secondary device while simultaneously preserving a macro or environmental view of the so-called play on a primary device. By introducing the secondary device for interpretation, the invention may provide more precision when a user is interpreting alone (scenario 1), improvements to the speed to interpret as a team (scenario 2) and the ability for real-time feedback and interpretation of seismic details during decision making meetings (scenario 3). In all scenarios, the present invention may allow new, more or improved visual perspectives when analyzing and presenting analysis of seismic data, which may result in an increased probability of a profitable well. Currently interaction of this type is not available to applicant's knowledge.

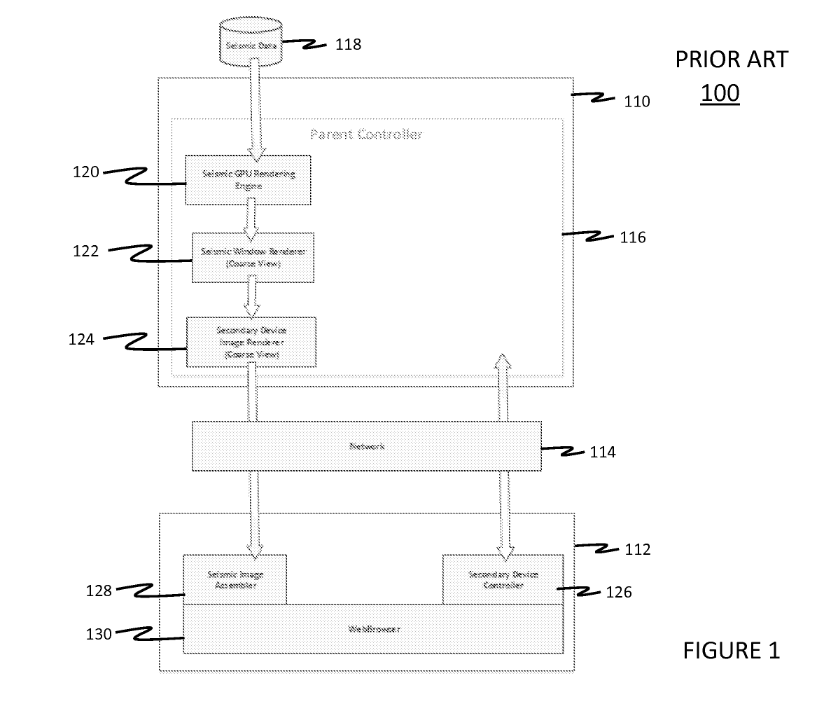

FIG. 1 depicts one example of a prior art system 100 that allows captured seismic data to be viewed on more than one device. The system 100 comprises a primary device 110, a secondary device 112 and a network 114 that allows communication between the two devices 110, 112. The primary device 110, which may also be referred to as a parent device, is a general purpose computing device, such as a personal computer. The primary device 110 includes various features of general purpose computing devices, such as, but not limited to: a controller 116, a memory system and a bus system that operatively connects, or couples, the controller to the memory system and other features. The parent device 110 is depicted as further including non-modifiable data 118, for example captured seismic data, which is stored within the memory system. A graphical processing unit (GPU) rendering engine 120, a window rendering engine 122 and a secondary device image renderer 124 are also depicted as being features of the primary device 110.

Within the system 100, the non-modifiable data 118 is retrieved from the memory and the GPU rendering engine 120 renders an image of a selection, or slice, of the non-modifiable data in one of various different perspectives. For example, the non-modifiable data 118 may be depicted in an image that includes one or more graphical representations of the non-modifiable data 118. The graphical representations of the non-modifiable data 118 may be a two-dimensional or three dimensional graph or image.

The window rendering engine 122 then makes the image of the non-modifiable data available for display by the primary device 110. For example the primary device 110 may have a display, such as a monitor or monitors. The secondary device image renderer 124 receives the image from the window rendering engine 122. The image is then communicated from the primary device 110 to the secondary device 112 by the network 114.

The secondary device 112 may comprise many of the same or different features as the primary device 110. In one embodiment, the secondary device 112 may also be a general purpose computing device, such as a personal computer. In another embodiment, the secondary device 112 may be a mobile computing device, such a lap top or a tablet computing device. The secondary device 112 may have a controller 126, an image assembler 128 and a web browser 130. The image that is communicated from the primary device 110 is assembled by the image assembler 128 and made available for display on the secondary device 112. Importantly, however, the image on the secondary device 112 may not be modified, annotated or otherwise changed by the secondary device 112. Any interactions with the image on the secondary device 112 may be limited to zooming in or out of the image and panning through different sections of the image because the data that is displayed on the secondary device 126 is merely a mirror of the data on the primary device 110, for example a mirror that is created by gaining remote access into the primary device 110 with the secondary device 112.

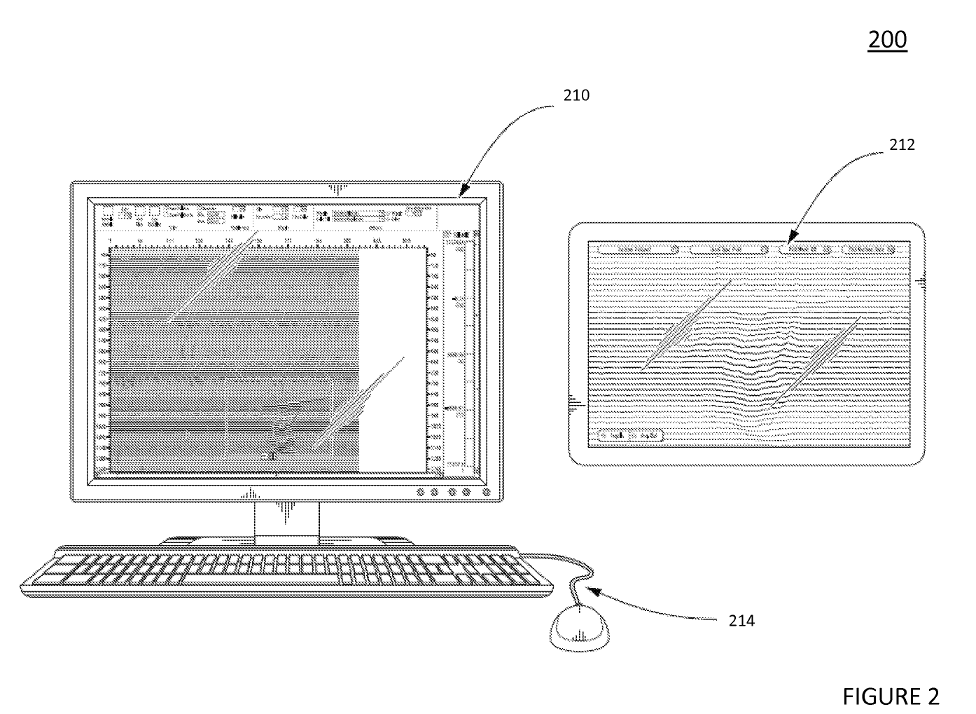

FIGS. 2 to 9, which are not intended to be limiting, depict various embodiments of the present invention that comprises a system 200. The system 200 is for processing data and comprises a primary device 210 and a secondary device 212. The primary device 210 may be a general purpose computer (PC) that includes the same, or different, features as the primary device 110 of the prior art. The primary device 210 may be a conventional PC, a server computer, a main-frame computer, a work-station, or in a semi-mobile computer such as a lap-top computer. The primary device 210 may include a display and a user input assembly 214. The display may be one or more of a fixed display, a desk-top monitor, a wall-mounted monitor, a suspended monitor, a projection and/or a projector screen (either front or rear projection), a hologram or combinations thereof. The user input assembly 214 allows a user to interact with the primary device 210.

The user input assembly 214 may include one or more of the following components: a mouse, a touch-sensitive screen, a track-ball, a touch-sensitive pad or trackpad, a joystick. The user input assembly 214 components may be of any useful size, key-board mounted or independent of other user input assembly 214 components, and wired or wireless. The user input assembly 214 components may also include one or more of the following components: a contactless pointer, including for example a light pen (including a laser or other wireless pointer), a virtual reality display, whether wearable or not, a holographic display, a head-up-display or other types of displays that provide a graphical user interface (GUI) that is interactive with a user's body motions and/or body positioning.

FIG. 2 depicts the secondary device 212 as being a mobile device, such as a lap top computing device, a tablet computing device, a so called smart phone or any other mobile computing device that cooperates with a display, for example, as defined above. It will also be understood that the secondary device 212 may also be a general purpose computing device.

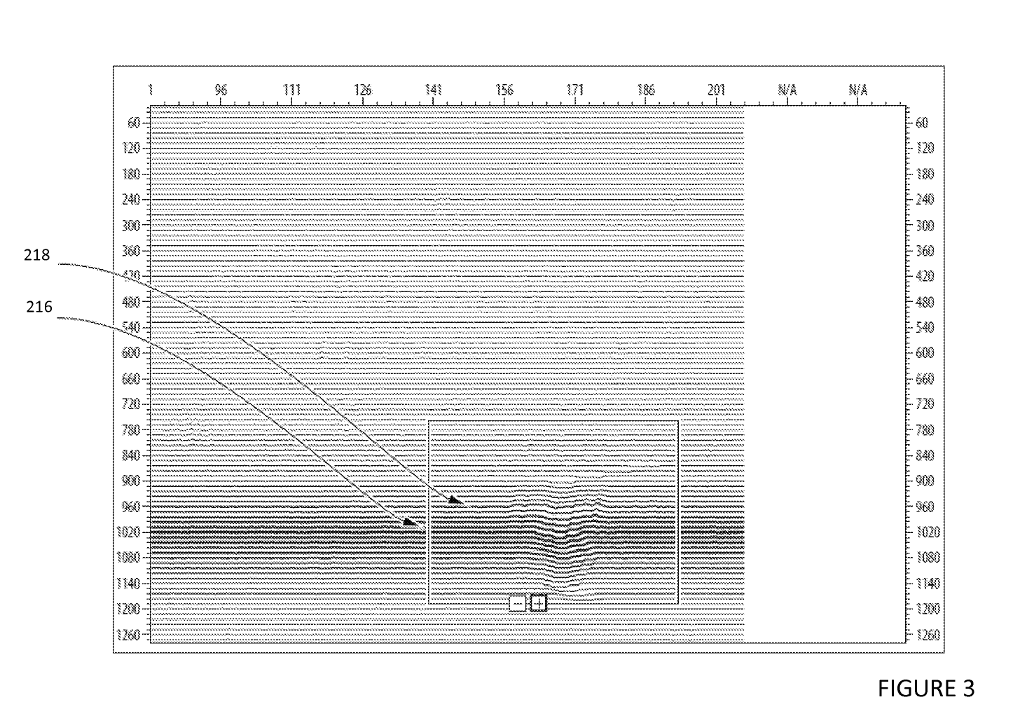

FIG. 3 depicts one example of a closer view of a displayed image of non-modifiable data 224 on the primary device 210. As will be described further below, the non-modifiable data 224 may be displayed as an image on the primary device 210. The image provides a macro view 216 of the non-modifiable data 224 that includes data traces that may be visualized as an image, such as wiggle lines. The data traces of the macro view 216 allow a skilled user to identify increases or decreases in amplitude of the data trace, which the skilled user may interpret as indicating a key event within the captured seismic data. The system 200 may automatically identify trends or individual key events within the captured data set and visually mark the trends or key events within the macro view 216 with different colours, or some other means to visually draw the skilled user's attention. The macro view 216 may also include an area of interest 218 which will be described further below.

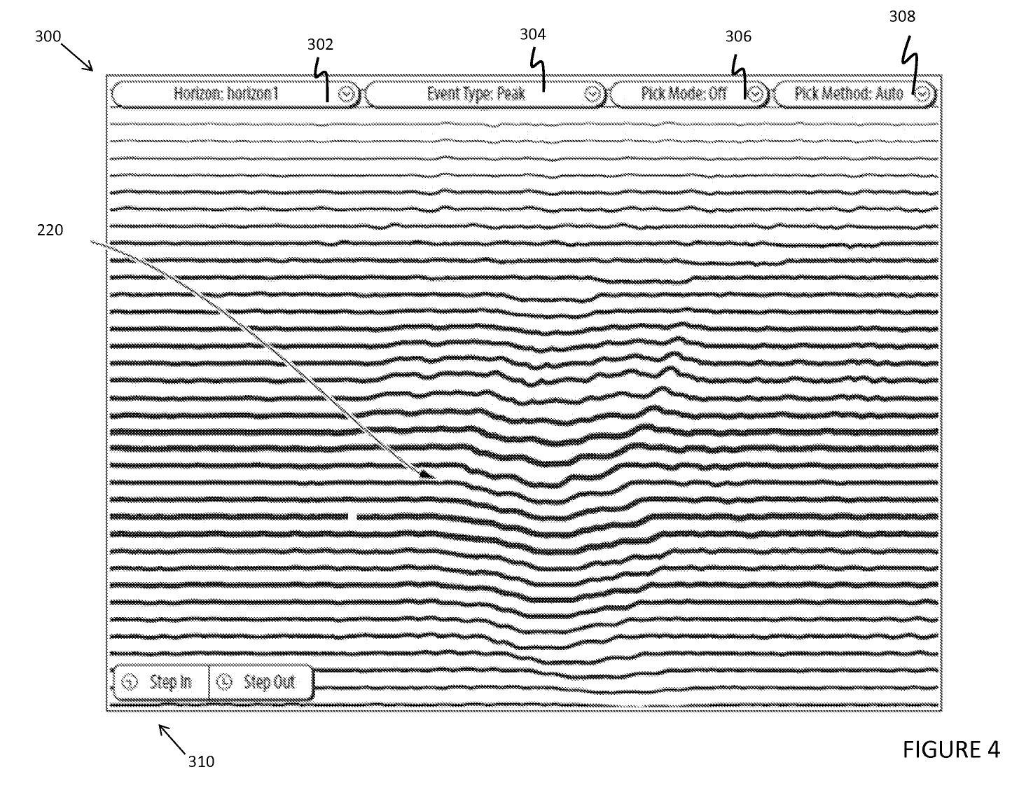

FIG. 4 depicts a scaled image that is displayed on the secondary device 212. The particular scaled image provided in FIG. 4 is from a slice of non-modifiable captured seismic data that falls within the area of interest 218 that is displayed on the primary device 210. For example, FIG. 4 may depict a fault event 220 that is within the captured seismic data.

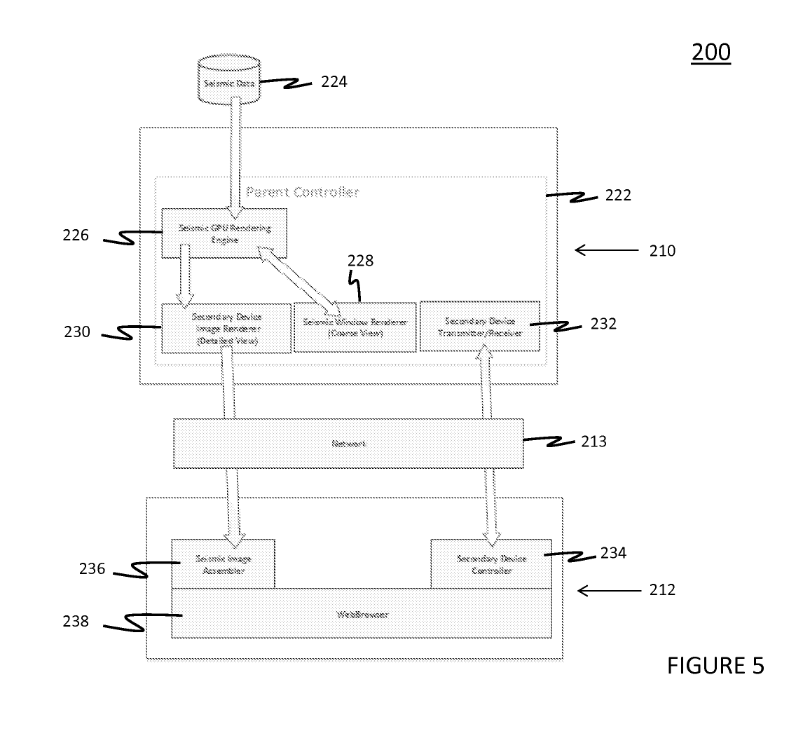

FIG. 5 a schematic representation of one embodiment of the system 200 and how it may operate within a computing environment. The primary device 210 is depicted as comprising a controller 222. The controller 222 is connected to the other features of the primary device 210 by a bus, which is not depicted in the figures but is understood to be a feature of the primary device 210. The primary device 210 includes a memory system that stores the non-modifiable data 224. The memory system is also not depicted in the figures but is understood to be a feature of the primary device 210. FIGS. 5 to 9 depict the non-modifiable data 224 with a label of seismic data and various other depicted features are similarly labelled with the word “seismic”. As will be appreciated by one skilled in the art, the non-modifiable data 224 may be captured seismic-data that is either two dimensional seismic data or three dimensional seismic data. However, the non-modifiable data may be or other types of data, particularly data that forms a data set of between about 10 and about 1000 gigabytes or larger.

As depicted in the embodiment of FIG. 5, the primary device 210 further comprises a window renderer 228 and a secondary device image renderer 230. At least all of these features may be operatively coupled with the primary device controller 222 via the bus. The window renderer 228 produces a coarse view of the non-modifiable data 224 that is made available for the display on the primary device 210. For example, the coarse view of the non-modifiable data 224 may be the macro view 216 depicted in FIGS. 2 and 3. The macro view 216 is a particular portion, which is also referred to as a slice or line, of the entire non-modifiable data 224.

The area of interest 218 may be selected within the macro view 216. For example, a default selection of the area of interest may be selected within the non-modifiable data 224, as represented by the rectangle within the macro view 216 in FIGS. 2 and 3. Alternatively, the user may select where and what size the area of interest 218 will occupy within the macro view 216.

The size and location of the area of interest 218 within the macro view 216 may be received by the GPU rendering engine 226 and included in the information sent to the secondary device image renderer 230. The secondary device renderer 230 renders a scaled image of the area of interest 218 within the macro view 216. The scaled image may also be referred to as a magnified proxy of the area of interest 218. The scaled image is scaled to substantially correspond to the dimensions, for example an aspect ratio, of a display on the secondary device 212. In one embodiment, the secondary device renderer 230 may default to a particular scale that will provide a fine level of detail within the scaled image when it is displayed on the secondary device 212. In this embodiment, the default scale may be adjusted based upon the specifications of the secondary device 212. Alternatively, the primary device 210 and the secondary device 212 may be wirelessly connected and undergo an exchange of specification information, which may be referred to as a “hand shake”, whereby information such as, but not limited to, the dimensional specifications of the secondary device 212 is provided to the primary device 210.

The transmitter/receiver 232 of the primary device 210 may be any hardware that is operatively couplable to the controller 222 and is configured for communicating with the secondary device 212 via the network 213.

The network 213 is configured to allow the communication of data and information between the primary device 210 and the secondary device 212. The communication of data and information may be via one-way transmissions from one device to the other or a two-way exchange of information between the devices 210, 212. In one embodiment, the network 213 is a wired network, such as a wired local area network, where the devices 210, 212 are hardwired to each other or communicate through a hardwired intermediary component. In another embodiment, the network 213 is a wireless means of communicating data and information, for example, a Wi-Fi network, a wireless local area network, electromagnetic transmissions in the infrared spectrum, a satellite-based network, an internet-based network or combinations thereof.

FIG. 5, which is not intended to be limiting, depicts the secondary device 212 as comprising a secondary device controller 234 and an image assembler 236. In one embodiment, the secondary device 238 may also comprise a web browser 238. The web browser 238 may be compatible with HTLM 5 or forward compatible with greater than HTML 5. The web browser 238 may provide a GUI on the secondary device 212 (as depicted in FIG. 4). The GUI may include GUI features 300, for example in the form of a menu bar, that may include a label feature 302, an event feature 304, a pick mode enabler feature 306, a pick method feature 308 and a stepping feature 310.

The label feature 302 allows a user to label or name a selection event, as described further herein below, for example “horizon1” as depicted in FIG. 4. The event feature 304 allows a user to identify specific types of key events, such as a peak, trough or a zero crossing. A peak is a continuous section of high amplitude values. A trough is a continuous section of low or negative amplitude values. A zero crossing may be interpreted as a point of contact between two different rock types which have different density, porosity or seismic velocities. The pick mode enabler 306 allows a user to toggle a pick-mode on and off. When in the pick mode is on, the user may perform selection events. When the pick mode is off standard touch web controls, such as finger swipes and pinches, may be effective for navigating about the scaled image or changing the area of interest that is displayed on the secondary device 212. The pick method feature 308 allows a user to toggle between a manual pick mode and an automatic pick mode. These modes are further described herein below. The stepping feature 310 allows a user to navigate through, or increment through, different three dimensional volumes, which are also referred to as slices of three dimensional data. When the use navigates and uses the stepping feature 310, the primary device 210 may have to update the scaled image based upon the extent of the user's navigation.

The secondary device 212 may receive the data that encodes the scaled image that is transmitted over the network 213 from the secondary device image renderer 230. The image assembler 236 assembles the scaled image and makes it available for display on the secondary device 212. When the scaled image is assembled, the system 200 provides two different perspectives, or views, of the same non-modifiable data: the macro view 216 may be displayed on the primary device 210 and the scaled image of the area of interest 218 may be displayed on the secondary device 212. Because the actual surface area of the display of the secondary device 212 may be larger than the two dimensional area within area of interest 218, as it is displayed on the primary device 210, the scaled image may provide a magnified view of the area of interest 218.

The user may generate one or more annotations on the scaled image by performing one or more selection events with the secondary device 212. For example, the user may pick a horizon of interest from within the scaled view. The user then performs a selection event to generate an annotation that is displayed on the scaled image. The annotation on the scaled view identifies the picked horizon that the user intends to analyze further.

As used herein after, the term horizon is intended to encompass other geological features, such as faults, salt dome or other structural or stratigraphic markers. The user will perform the selection event to pick a horizon, which assists the user in identifying a horizon that may be a peak, a trough or a zero crossing within the captured seismic data. The horizons serve as a baseline for further analysis and play a major role in the results of the entire interpretation process. The selection events may be one of a touch event upon a touch sensitive device of the secondary member. A touch event may be a tracing of the motion of a user's finger or a stylus across the touch sensitive device. Alternatively, the selection event may be a performed by another type of selection device of the secondary device 212, for example, a keyboard, a mouse, a track ball, a joystick, any other type of selection device that a skilled person would appreciate is suitable, or combinations thereof. Following the selection event, the annotation may be visible on the secondary device 212, for example, as a coloured line.

When the user performs a selection event, they are picking a horizon for further analysis. Yet, because the secondary device 212 often lacks the appropriate processing power to allow the user to further analyze the picked horizon on the secondary device 212, the processing occurs on the primary device 210. For example, the secondary device controller 234 is configured to communicate annotation information to the primary device 210 that includes any annotations made by the user as the annotations relate to the scaled image. For example, if the user identifies and picks a horizon within the scaled image, the user may annotate that pick by performing a selection event i.e. tracing a line over the horizon within a specific portion of the scaled image. The secondary device 212 generates the annotation, which is a visual depiction of the trace that is displayed upon the scaled image on the secondary device 212. The secondary device 212 does not have any direct access to the non-modifiable data 224 and, typically, nor does the secondary device 212 have the processing power that is required for further analysis of the pick. As such, the secondary device 212 identifies a location as to where on the scaled image the user has performed a selection event and generates data to record that location. This data may be referred to as the annotation information, the location of the selection event information or the picked horizon information.

The secondary device controller 234 communicates the location of the one, or more, selection events that are displayed upon the scaled image by communicating the annotation information to the primary device 210 via the network 213. For example, when the network 213 is wireless, the secondary device transmitter/receiver 232 may receive the annotation information, which may also be referred to as the location of the selection event information, in relation to the scaled image from the secondary device 212.

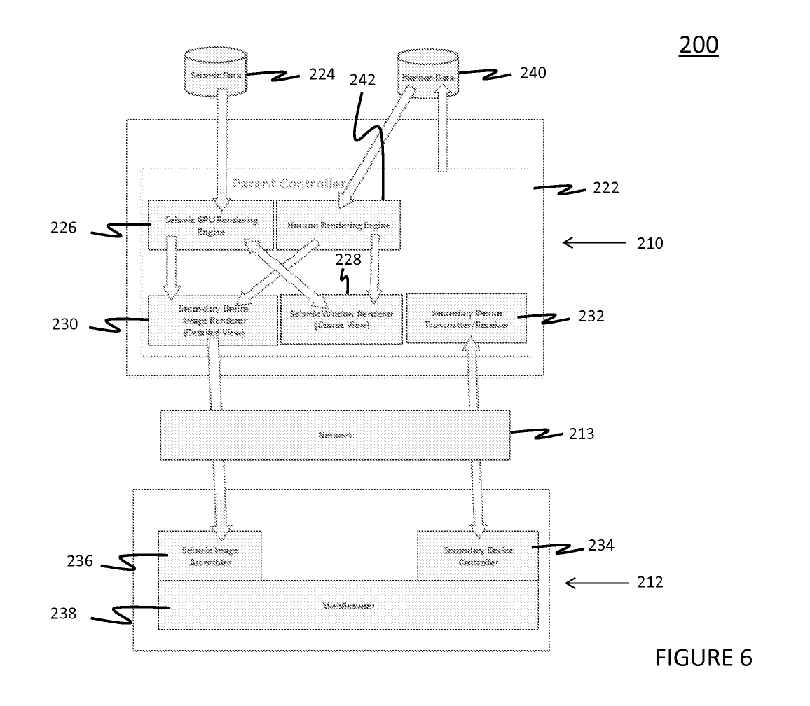

Upon receiving the annotation information, the controller 222, or some other lower order processor of the primary device 222, may generate modifiable data 240, the modifiable data 240 may also be referred to as the horizon data. The modifiable data 240 may be stored on the memory system of the primary device 210. For example, the modifiable data may be a translated, or transformed, version of the annotation information location of the data that reflects the annotations, or selection events, made by the user upon the scaled image. The modifiable data inserts a visual depiction of the annotation into the modifiable data 240. The modifiable data 240 is then sent to a horizon rendering engine 242 (see FIG. 6) for rendering a modified image that includes a visual depiction of the horizon that the user picked on the secondary device 212. The modified image is sent to the secondary device image render 230 for generating a scaled modified image that substantially matches the dimensions of the display of the secondary device 212.

The scaled modified image is then communicated to the secondary device image assembler 236 of the secondary device for assembly of the scaled modified image by the image assembler 236, which makes the scaled modified image available for display on the secondary device 212.

In one embodiment, the horizon rendering engine 242 also sends the modified image to the window renderer 228 to update the macro view 216. For example, if the user performs a selection event to pick a horizon in the scaled image, the selection event generates annotation information that is communicated to the primary device 210. The primary device 210 may generate and store the modified data so that the picked horizons are not lost. The primary device 210 then generates a modified image of the picked horizon, for example by adding a coloured line into the data, which is then scaled and communicated to the secondary device 212 for display. The primary device 210 may also modify the macro view 216 to allow the user to visualize the picked horizon within the macro view 216.

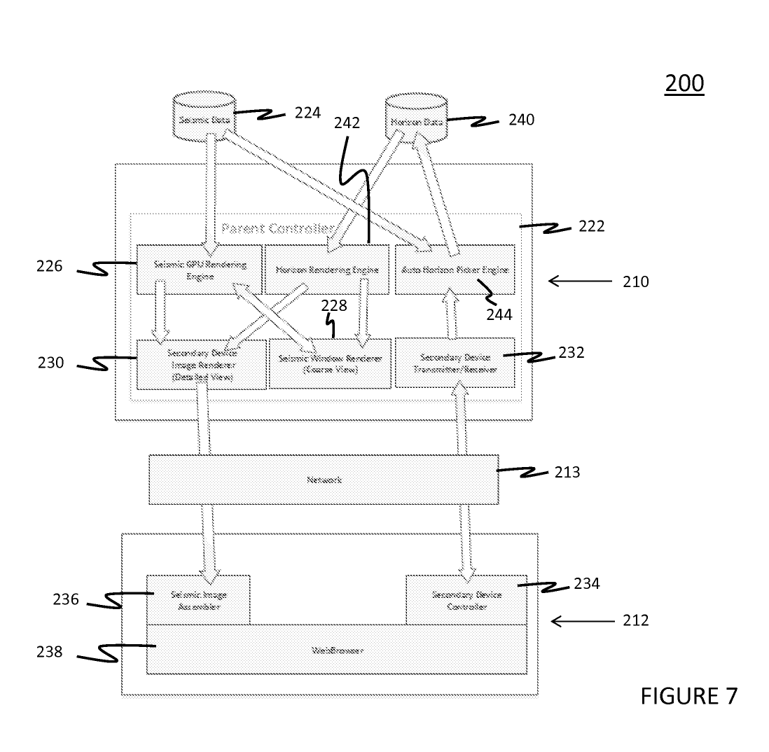

In one embodiment, the user may perform selection events in one of two modes: a manual pick mode and an automatic pick mode. As described above, the user may toggle between these two modes using the pick method feature 308 in the GUI features 300 provided by the web browser 238. In the manual mode, the user's performance of a selection event will generate an annotation upon the scaled image. The annotation may be a trace of substantially where the user has placed the selection event, for example, where the user has traced with their finger. That trace will, in effect, become part of the modifiable data 240 and the trace will become a visual feature of the modified image. Whereas, in the automatic mode, the annotation information is modified by an auto horizon picker engine 244 (see FIG. 7). The auto horizon picker engine 244 initially modifies the annotation data to determine a line, or curve, of best fit. The modifications are based upon one or more algorithms that snap the user's annotation to one or more mathematical characteristics of the non-modifiable data (such as peaks, troughs or zero crossings) within the non-modifiable data, as retrieved by the auto horizon picker engine 244 from the non-modifiable data 224. The snap to peak modifications of the annotation information is then passed to the modifiable data 240 for storage and to the horizon rendering engine 242 for rendering the modified image.

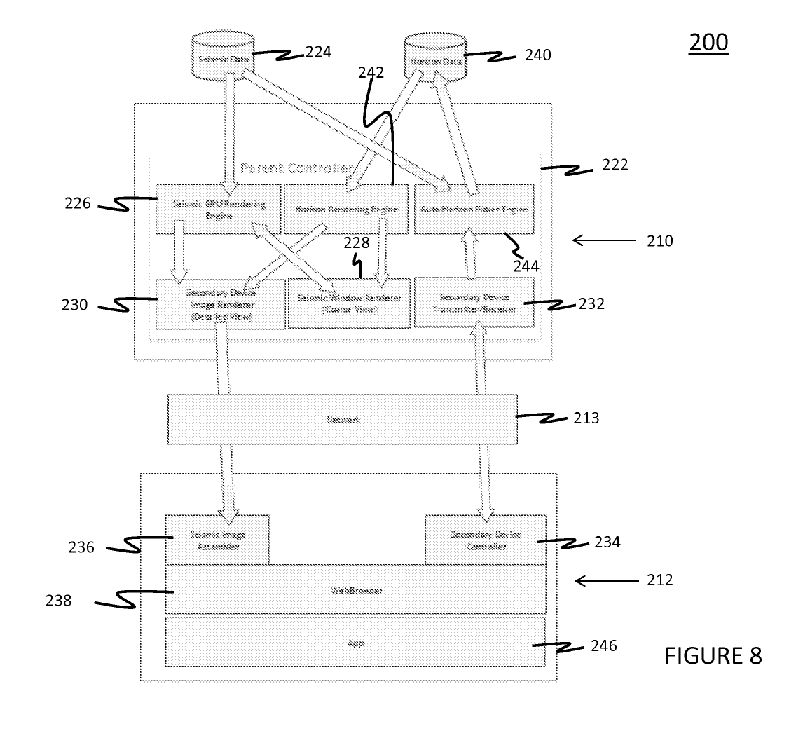

Another embodiment of the system 200 is depicted in FIG. 8, wherein the secondary device 212 is a further includes a mobile application 246, also referred to as an app, so that the web browser is compatible with the operating system of the secondary device 212, such as an Apple™, Windows™, Android™ or LinUX™ operating system.

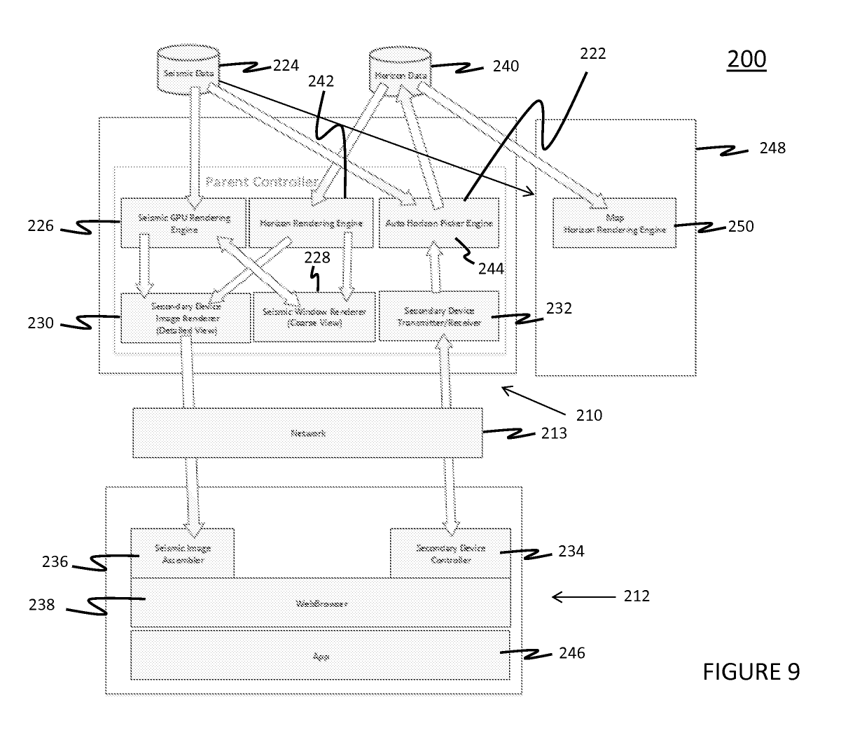

Another embodiment of the system 200 is depicted in FIG. 9, wherein the system 200 further comprises a map view 248 that is made available for viewing on the primary device 210. The map view 248 may be generated by a map horizon rendering engine 250 to provide a larger scale view, for example a top plan view of the entire region, or a portion thereof, from which the seismic data was captured. The horizon map rendering engine 250 may generate a first map image by receiving data from the non-modifiable data 224 and rendering the map view 248, which is then available for display. Alternatively, the horizon map rendering engine 250 may render all map views 248, including a first map view, based upon the modifiable data 240 after the user performs a selection event and the modified data is generated and saved. After rendering, the map view can be made available for display. The modified map view reflects the annotations of the user's selection events that are made on the secondary device 212 and incorporated into the modifiable data 240.

Example Scenario 1: Improvements in Quality of Seismic Interpretation by a Single User

In this scenario a single user is looking for key events in the seismic data. Most geophysical interpretation software packages allow for several methods to automatically select key events. With very good seismic data this could result in a high precision pick of a topological substructure but there will almost always be times when the user needs to manually ‘re-pick’ the feature data of interest, i.e. sections of the captured seismic data to ensure that the user's analysis and interpretation are following the shape of the substructure. Conventionally, the only way to achieve the re-picking is to view two perspectives of the same captured seismic data; that is, one view that shows all of the captured seismic data and the other view may be zoomed into the area of interest for re-picking. The user then typically re-picks a horizon on the zoomed perspective using a mouse. With the present invention, the area of interest is shown on the secondary device 212 as the zoomed in scaled image, while the macro view 216 is maintained and displayed simultaneously on the primary device 210.

The secondary device 212 may allows the user the ability to hold the scaled image as close to their eyes as needed, which may increase precision. Some users, particularly those with certain motor control issues, may find that performing selection events with their finger or a stylus may allow for more control. This may increase the precision and the quality of the final interpretation of the data set.

Scenario 2: Improvements in Speed and Quality of Seismic Interpretation by a Team of Users

When interpreting larger areas is it conventional to subdivide the work among multiple Interpreting Geophysicists. Each Interpreting Geophysicist on the team may be given a subsection of the data set that they need to interpret. Their work is then merged back together again for the whole area displayed in the macro view 216. Areas of overlap within the merged data may be reviewed together or with a senior Interpreting Geophysicist to ensure continuity of the geological structures within the areas of overlap. Currently each Interpreting Geophysicist would independently work on the overlapping areas of the merged sections at their own desktop. They then must agree who interpreted the overlapping areas correctly, or they would have to meet together to interpret the overlapping areas with only one person controlling the user input assembly 214 or they would have to share the user input assembly 214. These methods can be frustrating and time consuming. With the present invention one Interpreting Geophysicist may interpret details within the areas of overlap within the merged data using the secondary device 212 while the other users observe on the primary device 210 that displays any annotations made on the secondary device 212, in real time. Furthermore, the user input assembly 214 may be used on the primary device 210 to increase the collaboration between the two, or more, people that are interpreting the areas of overlap.

Scenario 3: Interactive Presentations of Interpretations of Seismic Data

In the current practice, static images of the whole play and subsets of the data are used to make the decision at a final funding presentation of a seismic interpretation. At these presentations, there may be other technical experts who participate in the decision making process and who are expected to critically assess the seismic interpretation. This critiquing process is critical to ensuring a high degree of confidence before investing multiple millions of dollars into a drilling project. It is difficult with static images alone for the other technical experts to explore details in areas of the interpretation that they may have concerns with. Even if the whole play is being shown on seismic interpretation software in the meeting, the only way for the other technical experts to explore areas they want in more detail on is to pass around the a mouse or keyboard or to have the experts move to where the mouse or keyboard are located in the meeting room. With the present invention, the technical experts may pass around the secondary device 212 (or several secondary devices 212), which may better preserve order in the meeting, promote collaboration while at the same time allowing for detailed review of the scaled view simultaneously with the macro view. This may allow a detailed critiquing by the technical experts to improve the chances that the group is making the right investment decision.

There can be further applications for this invention beyond geophysics and seismic interpretation. This invention has general applicability in many situations where there is a desire to show multiple levels of detail and interact concurrently between workstations and mobile devices. This may be employed in any situation where a user wishes to use a child mobile device to inspect, manipulate, and/or clean-up a detailed view (i.e., to modify feature data) while in real time updating and synchronizing the primary device 210 macro view 216.

While the above disclosure describes certain examples of the present invention, various modifications to the described examples will also be apparent to those skilled in the art. The scope of the claims should not be limited by the examples provided above; rather, the scope of the claims should be given the broadest interpretation that is consistent with the disclosure as a whole.

What is claimed is:

1. A method for processing data comprising steps of:
a. retrieving non-modifiable data;
b. rendering a first image of the non-modifiable data;
c. making the first image available for display on a primary device;
d. receiving a selected portion from within the first image;
e. rendering a scaled image of the selected portion to substantially match dimensions of a secondary device display of a secondary device; and
f. communicating the scaled image to the secondary device.

2. The method of claim 1, further comprising steps of:
a. receiving the scaled image;
b. making the scaled image available for display on the secondary device;
c. receiving a selection event for generating an annotation on the scaled image;
d. generating annotation information, wherein the annotation information includes providing a location of where the selection event occurred on the scaled image;
e. communicating the annotation information to the primary device.

3. The method of claim 2, further comprising steps of:
a. receiving the annotation information;
b. generating modifiable data for rendering a modified image that includes a visual depiction of the annotation information;
c. rendering a scaled modified image to substantially match the dimensions of the secondary device display;
d. communicating the scaled modified image to the secondary device.

4. The method of claim 3, further comprising steps of:
a. receiving the scaled modified image;
b. making the scaled modified image available for display on the secondary device.

5. The method of claim 2, wherein the selection event is selected from a group consisting of a touch event and a selection device event.

6. The method of claim 5, wherein the step of generating modifiable data further comprises a step of generating a curve of best fit.

7. The method claim 3, further comprising steps of:
a. retrieving the modifiable data for rendering a modified first image; and
b. making the modified first image available for display on the primary device.

8. The method of claim 1, further comprising steps of:
a. rendering a map view; and
b. making the map view available for display.

9. The method of claim 4, further comprising steps of:
a. rendering a map view from the retrieved non-modifiable data;
b. making the map view available for display;
c. retrieving the modifiable data for rendering a modified map view; and
d. making the modified map view available for display.

10. The method of claim 4, further comprising a step of providing the primary device and the secondary device, wherein the steps of claims 1 and 3 are performed on the primary device and the steps of claims 2 and 4 are performed on the secondary device.

11. The method of claim 1, wherein the non-modifiable data is captured seismic data.

12. A system for processing data, the system comprising: a primary device, a secondary device and a network that enables communication between the first device and the second device, wherein the primary device is adapted to perform steps of:
a. retrieving non-modifiable data;
b. rendering a first image of the non-modifiable data;
c. making the first image available for display on the primary device;
d. receiving a selected portion from within the first image;
e. rendering a scaled image of the selected portion to substantially match dimensions of a secondary device display of the secondary device; and
f. communicating the scaled image to the secondary device.

13. The system of claim 12, wherein the secondary device performs steps of:
a. receiving the scaled image;
b. making the scaled image available for display on the secondary device;
c. receiving a selection event for generating an annotation on the scaled image;
d. generating annotation information, wherein the annotation information includes providing a location of where the selection event occurred on the scaled image;
e. communicating the annotation information to the primary device

14. The system of claim 13, wherein the primary device further performs steps of:
a. receiving the annotation information;
b. generating modifiable data for rendering a modified image that includes a visual depiction of the annotation;
c. rendering a scaled modified image to substantially match the dimensions of the secondary device display;
d. communicating the scaled modified image to the secondary device.

15. The system of claim 14, wherein the secondary device further performs steps of:
a. receiving the scaled modified image;
b. making the scaled modified image available for display on the secondary device.

16. The system of claim 13, wherein the selection event is selected from a group consisting of touch events and selection device events.

17. The method of claim 15, wherein the primary device further performs a step of generating a line of best fit after receiving the annotation information.

18. The system of claim 14, wherein the primary device further performs steps of:
a. rendering a map view;
b. making the map view available for display.
c. retrieving the modifiable data for rendering a modified map view; and
d. making the modified map view available for display.

19. The system of claim 12, wherein the non-modifiable data is captured seismic data.
